(19) United States
(12) Patent Application Publication
(10) Pub. No.: US 2005/0240480 A1
(43) Pub. Date: Oct. 27, 2005

(54) Display method for pos system

(75) Inventor: Masakazu Ito, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 11/063,720

(22) Filed: Feb. 24, 2005

(30) Foreign Application Priority Data
Feb. 20, 2003 (JP) 2003-042206

(51) Int. Cl. G06F 17/60

(52) U.S. Cl. 705/16

(57) ABSTRACT

A display system for POS system for executing POS processes based on data of goods dealt with in a shop to be displayed in a display view. Data set for each shop is produced as desired and displayed in predetermined places of the view.

### BACKGROUND OF INVENTION

The present invention relates to display systems for POS system and, more particularly, to display systems for POS system, which are for use in, for instance, fast food shops and restaurants, and can display data peculiar to each shop as desired with efficient management.

The POS system is used in various shops such as supermarkets and fast food shops, and for real-time obtaining of various data such as sales data, and is very important in the sales tactic viewpoint as well.

Recently, in many prior art POS system liquid crystal display is used. Specifically, transparent electrodes are disposed on a liquid crystal panel, and any one of a plurality of keys, which are impressedly formed on the transparent electrode and correspond to goods, processes, etc., are specified by touching the same with a finger.

FIG. 8 shows a sales view raised on the screen of the POS display. As shown, the sales view is usually constituted by a key top showing the whole sales view, key groups showing process/sales buttons, labels showing head/comments and an active window showing detail fields.

Due to restriction on the number of buttons capable of being disposed in the POS display view, a plurality of views is made to correspond to a necessary key item. The unit of views in this case is the key top. In the key top, the key groups and keys are disposed. Each key group is displayed at a position defined by its coordinate data, and it has key and label data. The active window designates, for instance, one account data display field at the time of sales, and it can be constituted by three fields of account head (i.e., customer data), sales details and account data.

In the prior art display system for POS system as described above, however, only head letter data is displayed in the view at a fixed place thereof. On the other hand, individual shop statuses and shops have peculiar desires, and sometimes specific display statuses are necessary. However, the prior art system can not flexibly cope with such desires.

### SUMMARY OF INVENTION

An object of the present invention is to provide a display system for POS system capable of display by appropriate or adequate comments, sentences and images (either alone or in hybrid) in desired places in dependence on kind and status of shops.

A more specific object of the present invention is to provide a display system for POS system capable of not only improving the visual confirmation property of the POS system sales view but also reduction of the error occurrence at the time of service or process with free disposition of comments of services, sales talks, etc. not only in sentences but also in images (or in hybrids of sentences and images).

As an embodiment of the present invention, it is provided a display system for POS system for executing POS processes based on goods data dealt with in shops and to be displayed in a display view, wherein data set for each shop are produced as desired and displayed in predetermined places in the view.

The data are of either letters, images or photographs or synthetic data of these data, data determined in correspondence to sales goods, or sales talk, service content, confirmation items at the process time or head of process or combinations of these data. Also, the font and color of the data are displayed in a different form those of other view displays.

Other objects and feature of the present invention will be clarified from the following description with reference to the attached drawings.

### BRIEF DESCRIPTION OF DRAWINGS

FIG. 1 is a view showing a display view example in an embodiment of the display system for POS system according to the present invention;

FIG. 2 is a view showing a data configuration example concerning the display image of key group G1 in the FIG. 1 view example;

FIG. 3 is a view showing a data configuration example concerning the display image of key group G2 in the FIG. 1 view example;

FIG. 4 is a view showing the title, display position, etc. concerning comment and image displayed in key group G3 in the FIG. 1 view example;

FIG. 5 shows a display view example in a different application of the display system for POS system according to the present invention with a restaurant as applied shop;

FIG. 6 shows a display image example in a further application of the display system for POS system according to the present invention with a restaurant as applied shop;

FIG. 7 is a view showing a display example in the case of a special display form of the head in the embodiment of the present invention; and

FIG. 8 is a view shopping a display view example on a display of a prior art display for POS system.

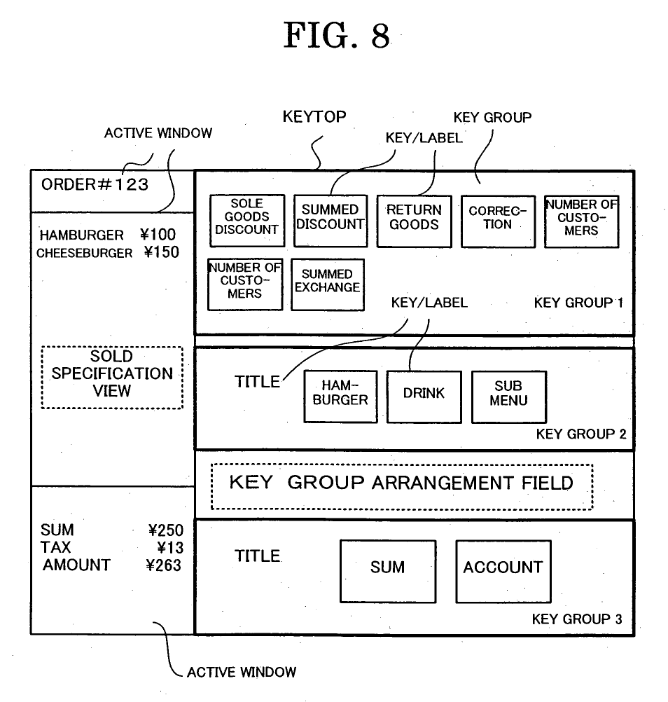

### PREFERRED EMBODIMENTS OF INVENTION

Preferred embodiments of the display system for POS system according to the present invention will now be described in detail with reference to the accompanying drawings.

According to the present invention, data of comments, sentences, images, photographs (either alone or hybrid), generated in dependence on the shop's kind or status, can be disposed and displayed in dependence on desired places. These data are versatile, and can be produced as desired.

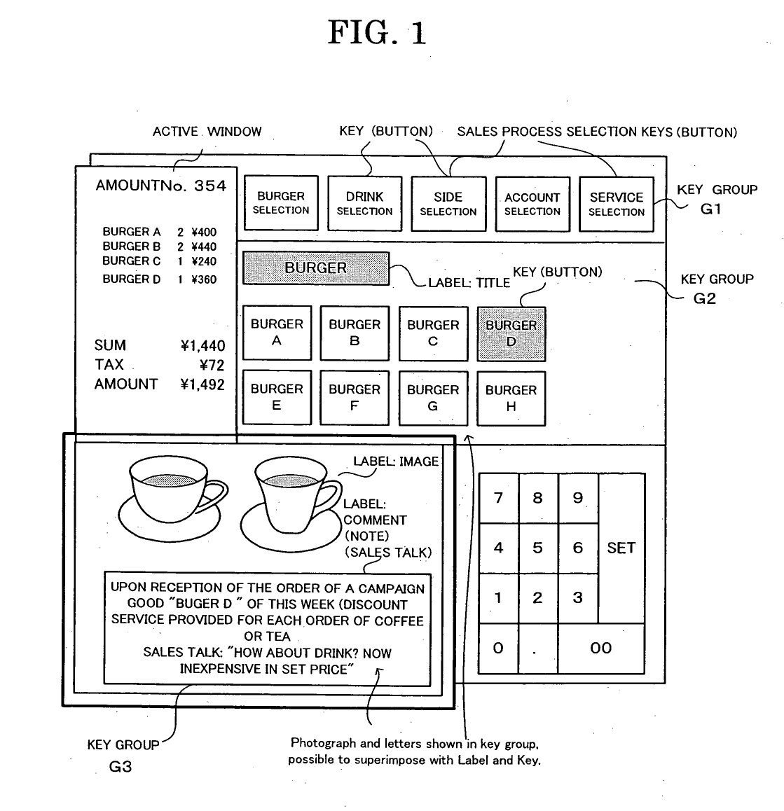

FIG. 1 is a view showing a display view example in an embodiment of the display system for POS system according to the present invention.

In the view as shown, like the prior art, key groups and various keys, labels (heads), etc. belonging to these key groups are displayed at predetermined positions. An active window is set, which has been made operative by a predetermined key operation. In this embodiment, the active window is a different goods sales view disposed as a left upper view, and it displays ordered (i.e., sold) goods, the prices thereof, amounts of the sold goods and the sum thereof.

Examples of the key groups will now be described. A key group G1 is constituted by sales process selection keys, for instance a burger selection key, a drink selection key, a side selection key, an account selection key and a service selection key. A key group G2 has goods selection keys. As the head of the goods, “Burger” is displayed at the top, and various kinds of goods, such as “Burger A” to “Burger H” are disposed. Key group G3 has specific data according to the present invention, such as comments, sentences and photographs (for instance comments and sales talks as “note” items). These data are disposed in predetermined places determined as desired in the view. In a left upper art of the view, data of the number of sales goods, the amounts and the sum amount are displayed. In a right lower part, a ten key set for numeral figure input is disposed.

In the sales process in a fast food shop, for instance, such a service as “With reception of the order of this good, this word is to be given to the customer”, is practiced. However, tentative workers (i.e., non-accustomed persons in charge) are often instructed to do service at all times, and it is therefore highly possible the occurrence of erroneous saying or forgetting of the saying of the sales talk. Also, even accustomed employees sometimes do mistakes at the time of a change or start of service. According to the present invention, the service content or sales talk description is displayed as data in a predetermined place of the view (i.e. part G3 in FIG. 1).

A more specific example will now be described with reference to FIG. 1. In a first service example, upon reception of the order of a campaign good “Burger D” of this week (with discount service provided for each order of coffee or tea), sales talk data such as “How about drink?, now inexpensive in set price.” is displayed in the view, and the employee gives this data to the customer while confirming the data, thus stimulating the purchase will. Also, lest the service and sales talk should be forgotten, it is possible to display the image of the service good (such as coffee or tea) and a comment thereof.

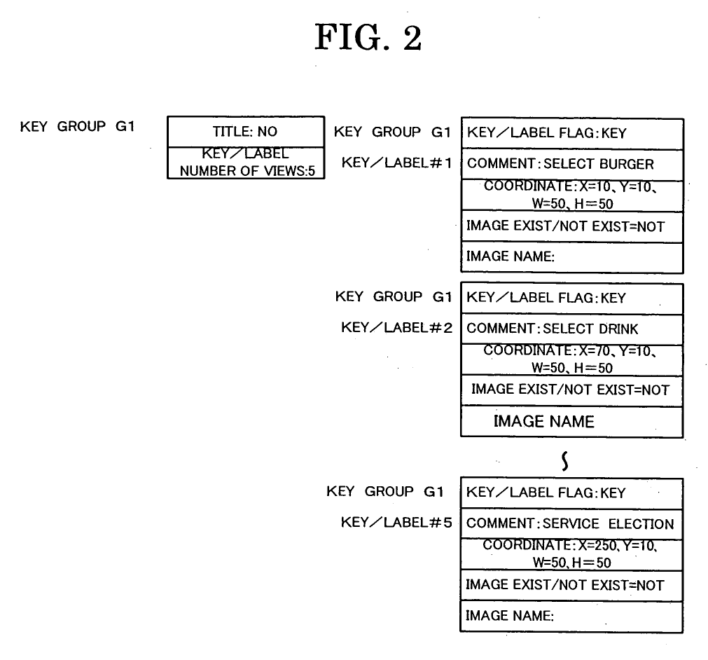

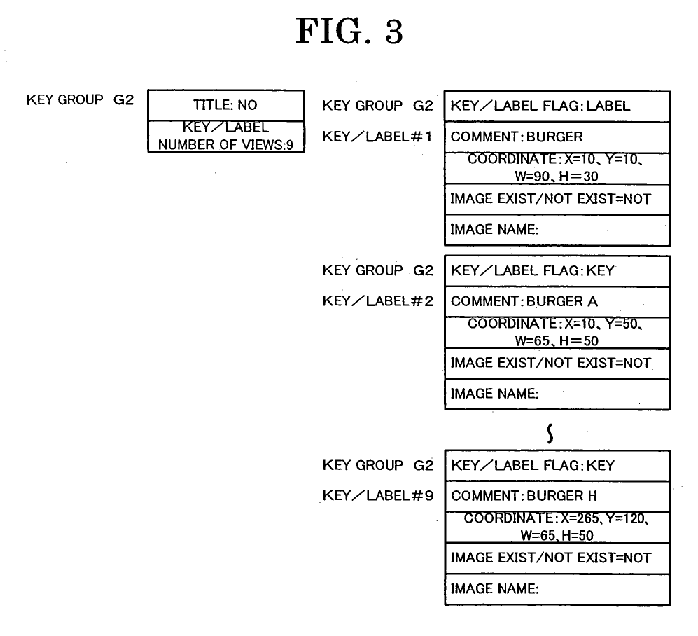

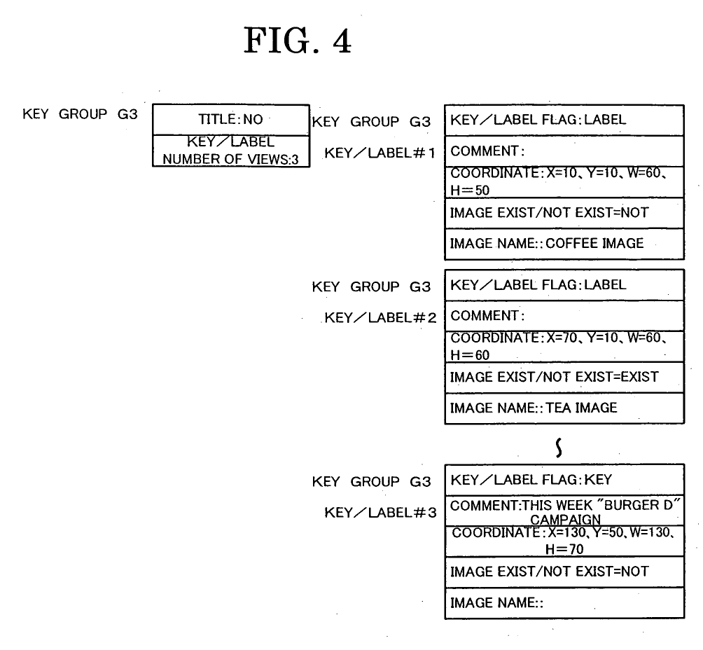

FIGS. 2 to 4 show data configuration examples concerning the display images in the FIG. 1 view example. As shown, data of the key/labels (such as burger selection, drink selection, service selection, “Burger A” to “Burger H”), comments and display positions in the key groups G1 to G3 are displayed. FIGS. 2 and 3 show titles and display positions of usual keys in the groups G1 and G2. FIG. 4 shows titles, display positions (coordinates), etc., concerning comments and images to be displayed in the key group G3 are displayed.

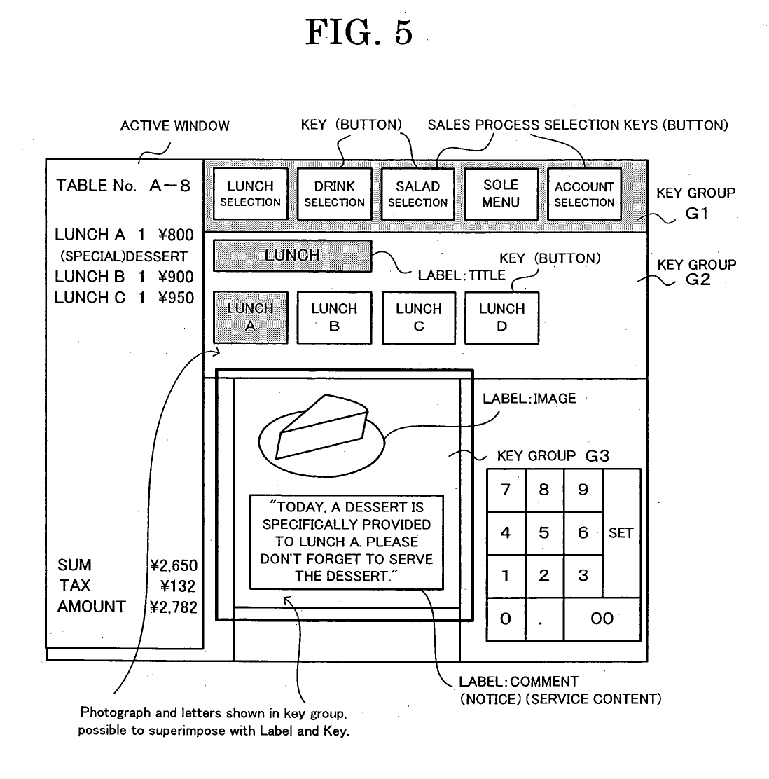

Now, a second service example in the display system for POS system according to the present invention will be described in connection to a case with a restaurant as applied shop with reference to FIG. 5. In the key group G1, “lunch selection”, “drink selection”, “salad selection”, “single good menu” and “account selection” are disposed. In the key group G2, “lunch A” to “lunch D” are disposed. In the key group G2, display of comment and image according to the present invention is disposed. In this example, in a restaurant upon reception of a customer's order, a slip is produced in the POS system, and the ordered good is registered. In this case, at the time of the registration of the ordered good in the POS system, the process is reliably and speedily executed with the display of the above data (i.e., service content) peculiar to the shop, which is useful. The comment display is particularly useful for error prevention in quickly switched services such as limited time services and lunch services.

For example, in the case that a desert is provided to “lunch A”, a service good at the lunch time of today, lest the service good is forgotten, the image of the service good (i.e., image of the dessert) and a comment that “Today, a dessert is specifically provided to “lunch A”. Please don't forget to serve the dessert.” are displayed in the view.

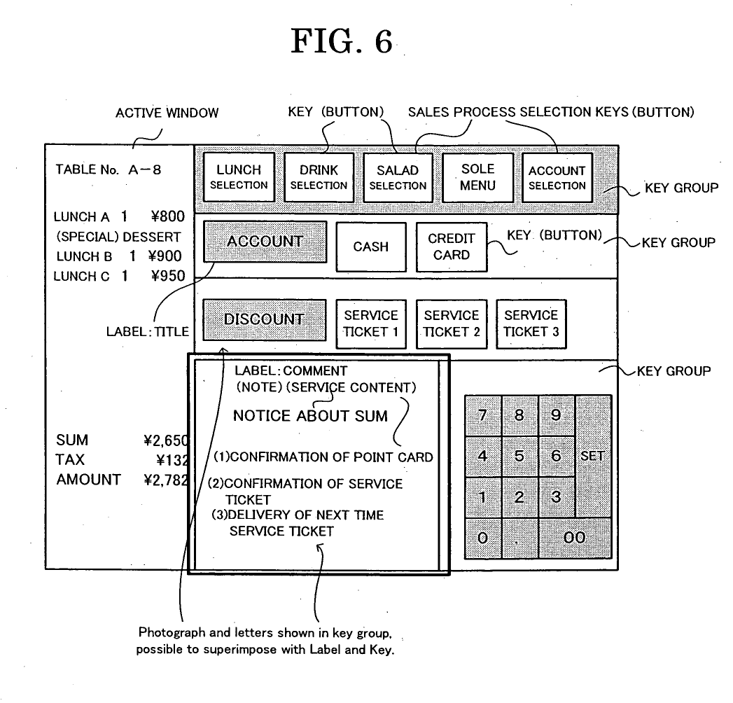

Now, a third service example in the display system for POS system according to the present invention will be described with reference to FIG. 6. This example is effective for executing various confirmations and processes such as collecting and dividing point cards, various service tickets and account amounts at the account time in the shop. In such shop processes, a plurality of confirmation items are involved, and the processes are cumbersome. In this example, the confirmation contents of the plurality of items are separately comment displayed to permit efficient confirmation of the processes. For example, at the account time the process can be executed efficiently with the display of (1) confirmation of point card, (2) confirmation (i.e., reception) of service ticket and (3) delivery of next time service ticket (presence of service ticket issued today).

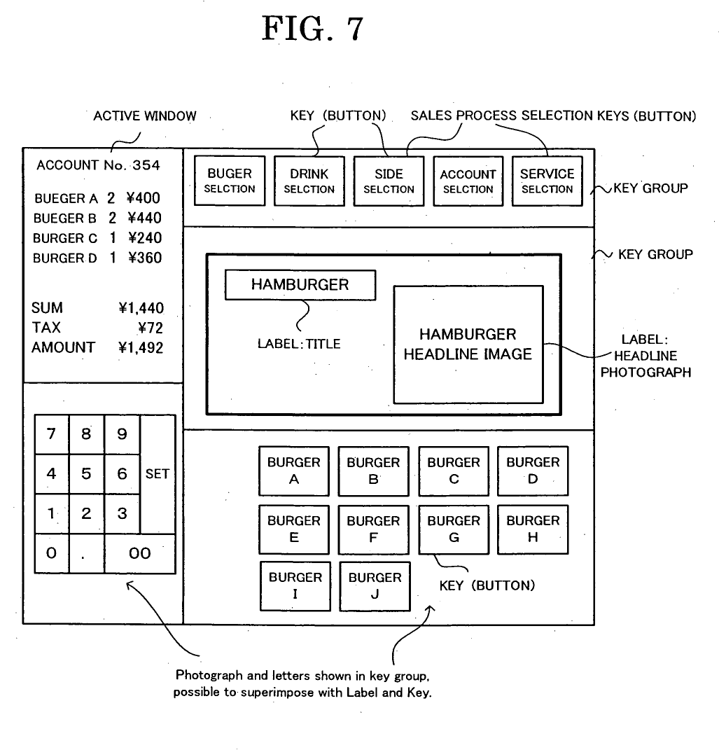

According to the present invention, as shown in FIG. 7, aside from the above display, the head of each process can be made to be of a specific display status. For example, it is possible to change the font and color to improve the visual confirmation property of the view function by using images or the like. For visual confirmation prosperity improvement, it is possible to display the process head together with image.

As has been described in the foregoing, with the display system for POS system according to the present invention it is possible to dispose and display adequate comments, sentences and images (either alone or in hybrid) in desired places in dependence on the kinds or statuses of shops. Thus, the view can be observed more easily, and the processes peculiar to individual shops can be executed adequately and speedily. For example, it is possible to reduce errors at the service time by freely disposing such comments as service and sales talks not only as sentences but also in images (including hybrid display). Also, it is possible to reduce erroneous processes by displaying peculiar messages and/or images for processes readily liable to errors.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A display system for POS system for executing POS processes according to goods data, which concern goods dealt with in a shop and displayed in a display view, wherein:
data set for each shop is produced as desired and displayed in predetermined places of the view.

2. The display system for POS system according to claim 1, wherein the data are of letters, images or photographs or combinations of these data.

3. The display system for POS system according to claim 1, wherein the data are determined in correspondence to sold goods.

4. The display system for POS system according to claim 1, wherein the data are of sales talks, service contents, confirmation items at the process time and process heads or combinations of these data.

5. The display system for POS system according to claim 1, wherein the font and color of the data are displayed in status different from those of other view displays.

6. The display system for POS system according to claim 2, wherein the data are of sales talks, service contents, confirmation items at the process time and process heads or combinations of these data.

7. The display system for POS system according to claim 3, wherein the data are of sales talks, service contents, confirmation items at the process time and process heads or combinations of these data.

8. The display system for POS system according to claim 2, wherein the font and color of the data are displayed in status different from those of other view displays.

9. The display system for POS system according to claim 3, wherein the font and color of the data are displayed in status different from those of other view displays.

10. The display system for POS system according to claim 4, wherein the font and color of the data are displayed in status different from those of other view displays.
